(19) United States
(12) Patent Application Publication
(10) Pub. No.: US 2007/0218430 A1
(43) Pub. Date: Sep. 20, 2007

(54) Calligraphy practicing system

(75) Inventors: Ben-Huang Chang, Taipei City (TW); Wen-Bing Horng, Taipei City (TW); Chin-Hwa Kuo, Taipei City (TW)

Correspondence Address: BRUCE H. TROXELL;SUITE 1404, 5205 LEESBURG PIKE, FALLS CHURCH, VA, 22041, US

(73) Assignee: TamKang University

(21) Appl. No.: 11/331,085

(22) Filed: Jan. 13, 2006

(30) Foreign Application Priority Data
Nov. 3, 2005 (TW) 094138550

(51) Int. Cl. G09B 19/00

(52) U.S. Cl. 434/155

(57) ABSTRACT

The present invention introduces a calligraphy practicing system that uses a tablet PC or a digital notepad to simulate a calligraphy practice environment that allows beginners or other learners to use the computer to learn to write Chinese characters. The calligraphy practicing system includes two subsystems, a hard pen calligraphy practicing subsystem and a soft pen calligraphy practicing subsystem, which provide two different Chinese calligraphy practice functions. With the calligraphy practicing system, a Chinese calligraphy learner can use the powerful simulating and computational abilities of the computer to greatly improve the effect of learning Chinese calligraphy.

### FIELD OF THE INVENTION

The present invention is a Chinese calligraphy practicing system which utilizes the powerful simulating and computational abilities of a computer to simulate an environment for practicing Chinese calligraphy on a tablet PC or a digital notepad, thus greatly improving the results of learning Chinese calligraphy.

### BACKGROUND OF THE INVENTION

The secret of Chinese characters and its profound cultural values are a precious asset for the Chinese, Chinese characters in a calligraphic form is considered a precious artwork and a cultural treasure around the world. At present, Taiwan is the only country that still uses traditional Chinese characters. It is therefore, naturally, the unspoken responsibility of the Taiwanese to maintain the usage of Chinese calligraphy. Since the age of computers, however, writing with pens in our daily lives has gradually been replaced with typing on the computer. Furthermore technological media has shifted the emphasis in the curriculum of today's basic education away from practicing calligraphy. This calligraphy practicing system integrates the technological media and digital transmission into a haven for teaching, demonstrating, and piquing interest in Chinese calligraphy.

### SUMMARY OF THE INVENTION

The primary objective of the invention is to provide a Chinese calligraphy practicing system which includes a hard pen calligraphy practicing subsystem in which a variety of auxiliary functions such as font size, stroke width, character tracing background, and stroke order reminder, etc. assist the learner in practicing writing in various fonts.

The secondary objective of the present invention is to provide a Chinese calligraphy practicing system which includes a soft pen calligraphy practicing subsystem in which a simulation of the stroke of a writing brush for writing Chinese characters in different fonts, such as Regular Script, Ancient Style, Seal Character, Wei Stone Script, and Inscription Bone Script, assists the calligraphy learner in practicing writing in these fonts.

### BRIEF DESCRIPTION OF THE DRAWINGS

FIG. 1 is a schematic layout of the hard pen calligraphy practicing subsystem according to the preferred embodiment of the present invention.

FIG. 2 is a flow chart depicting the learning process using the hard pen calligraphy practicing subsystem of the present invention.

FIG. 3 is a schematic view of selecting a character from the hard pen calligraphy practicing subsystem of the present invention.

FIG. 4 is a schematic view of tracing a selected font according to stroke order defined in the hard pen calligraphy practicing subsystem of the present invention.

FIG. 5 is schematic diagram illustrating the adjustment of tracing speed and stroke width according to stroke order while tracing a selected font defined in the hard pen calligraphy practicing subsystem of the present invention.

FIG. 6 is a schematic diagram illustrating the display of the learner's progress in practicing a stroke order of a selected font in the hard pen calligraphy practicing subsystem of the present invention.

FIG. 7 is a schematic view of the handwriting practice background setup in the hard pen calligraphy practicing subsystem according to a preferred embodiment of the present invention.

FIG. 8 is a schematic view of the handwriting practice font size setup in the hard pen calligraphy practicing subsystem of the present invention.

FIG. 9 is a schematic view of the handwriting practice stroke width setup in the hard pen calligraphy practicing subsystem of the present invention.

FIG. 10 is a schematic view of the handwriting practice result in the hard pen calligraphy practicing subsystem of the present invention.

FIG. 11 is a flow chart depicting the learning process in the soft pen calligraphy practicing subsystem of the present invention.

FIG. 12 is a schematic view of the handwriting tracing playback in the soft pen calligraphy practicing subsystem of the present invention.

FIG. 13 is a schematic view of the various functions in the soft pen calligraphy practicing subsystem of the present invention.

FIG. 14 is a schematic view of the background grid setup in the soft pen calligraphy practicing subsystem of the present invention.

FIG. 15 is a schematic view of the stamp function in the soft pen calligraphy practicing subsystem of the present invention.

FIG. 16 is a schematic view of another stamp function in the soft pen calligraphy practicing subsystem of the present invention.

### DESCRIPTION OF THE PREFERRED EMBODIMENT

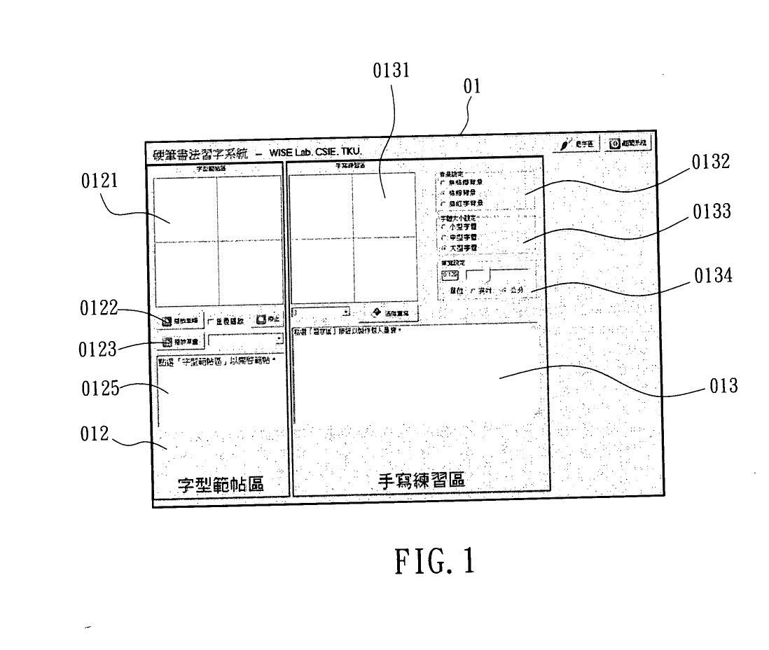

Refer to FIG. 1, which shows a schematic view of the hard pen calligraphy practicing subsystem according to a preferred embodiment of the present invention: The so-called “hard-pen calligraphy” is done with a fountain pen, a pencil, a ball pen, or a roller pen, whereas the hard pen calligraphy practicing subsystem of the invention uses a tablet PC or a digital notepad to create an environment for practicing Chinese calligraphy on a computer.

In FIG. 1, the hard pen calligraphy practicing subsystem 01 of the Chinese calligraphy practicing system of the invention comprises a copybook area 012, represented by the icon of [symbol] and a practice area 013, represented by the icon of [symbol] . The copybook area 012 further comprises a model font copybook display area 0121, a stroke order playback icon 0122, a stroke playback icon 0123, a repeat playback icon 0124, and a reminder area 0125, represented by the icons [symbol] , [symbol] , [symbol] , [symbol] , and [symbol] , respectively. The practice area 013 further comprises a handwriting practice display area 0131, a background setup icon 0132, a font size setup icon 0133, and a stroke width setup icon 0134, represented by the icons [symbol] , [symbol] , [symbol] , and z,11 , respectively.

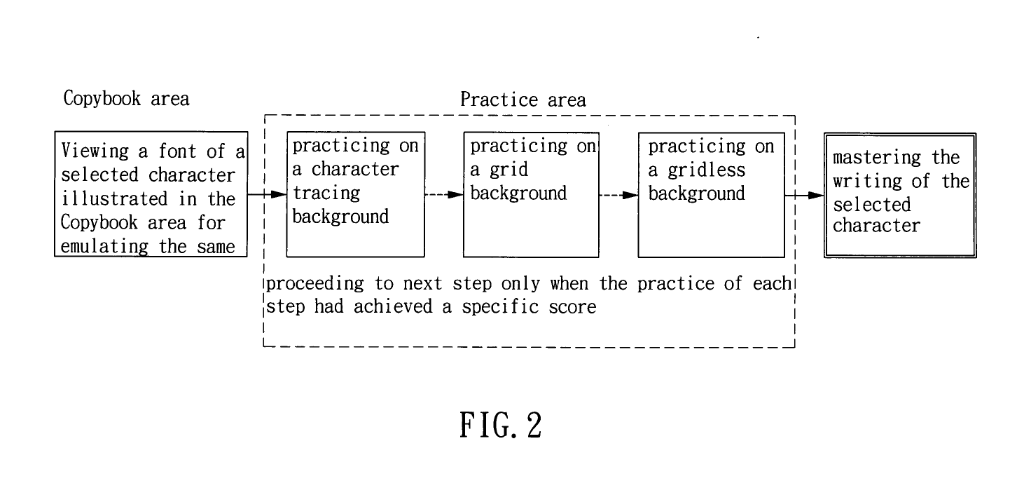

For self-studying learners of Chinese calligraphy, the hard pen calligraphy practicing subsystem of the invention applies a refined practicing strategy and a framework concept. To start with, a learner views and observes the playback of stroke order of a selected font illustrated in the copybook area 012 to familiarize himself or herself with the basic points and lines (including the points and strokes) of the font. After viewing the basic points and lines, the learner can then proceed to practice area 013 to practice writing a character of the font, followed by successive practices in a character tracing background, a grid background, and finally, in a gridless background. The corresponding score given by the handwriting evaluation is a guideline to how familiar the learner is with a character's stroke order, font structure, and force of the pen. Refer to FIG. 2 for the whole learning process.

For calligraphy teachers, traditional calligraphy teaching includes motivation, explanation of key points, demonstration, practice, evaluation, and appreciation, wherein the practice step includes the repeated steps of demonstration, imitation, commentary, correction, reimitation, and recorrection. However, this traditional style of teaching is time consuming for both individual learners and teachers. With the Chinese calligraphy practicing system of the present invention, the manpower and the time required can be greatly reduced. The learner views the demonstration from a system built-in copybook first, and then follows the instructions given by the system to practice the writing. Finally, the system provides feedback to the learner for making corrections. The learner practices repeatedly for a better result. Refer to Table 1 as shown below for the detailed teaching application mode.

TABLE 1
Comparison of teaching mode between traditional calligraphy
and hard pen calligraphy practicing subsystem

| Teaching | | |
|---|---|---|
| Mode of | | |
| Traditional | | Teaching Mode of Hard Pen Calligraphy Practicing |
| Calligraphy | | Subsystem |
| 1. | Motivation | In the course design, the contents include nine major |
| 2. | Key-Point | teaching events, and the contents are expressed in a |
| | Explanation | multimedia form, (texts, graphics, photos, images, |
| 3. | Demonstration | and animations, etc). The teacher illustrates and |
| | | explains the contents according to the screen |
| | | displayed. |
| 4. | Practice | The hard pen calligraphy learning technique is used |
| | A. Demo | for practicing characters. Since the system includes |
| | B. Imitation | a built-in copybook, the learner can freely select the |
| | C. Criticism | desired character for practicing and correct any |
| | D. Correction | mistakes using the results of the evaluation and |
| | E. Reimitation | comments as guidelines. |
| | F. Recorrection | |
| 5. | Evaluation and | The learner can upload the finished work through |
| | Appreciation | the system for the teacher to grade, and use a built- |
| | | in recording feedback mechanism to describe any |
| | | mistakes made by the learner. |

Various functions of the hard pen calligraphy practicing subsystem in the Chinese calligraphy practicing system of the present invention is described with attached drawings below:

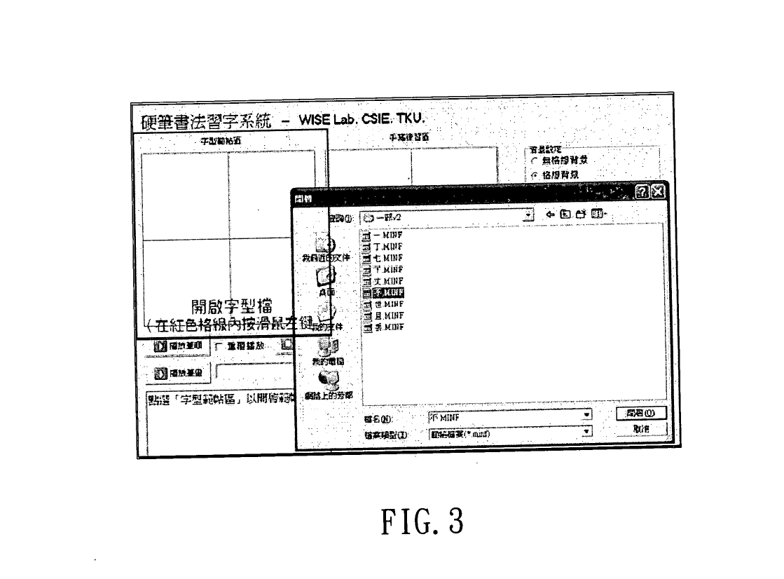

In the hard pen calligraphy practicing subsystem, the functions provided in the copybook area are shown in FIG. 3. The calligraphy learner can open a font file for practicing the calligraphy, and the Chinese character [symbol] is used for the illustration of the preferred embodiment.

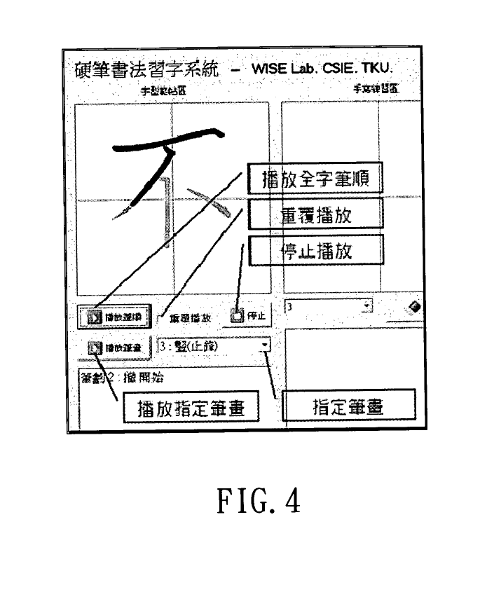

Refer to FIG. 4: The calligraphy learner can select different functions including full character stroke order playback, specified stroke order playback, and repeated playback by selecting icons of [symbol] , [symbol] , and [symbol] respectively for practicing the writing of a character according to its stroke order.

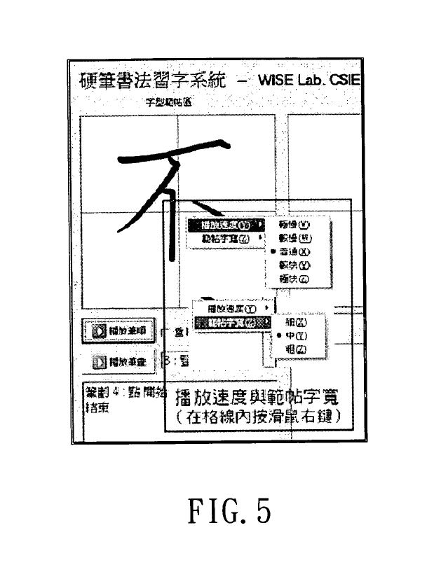

Refer to FIG. 5: The calligraphy learner can select the speed of the stroke order playback and adjust the word width of the selected font to be displayed in the copybook area.

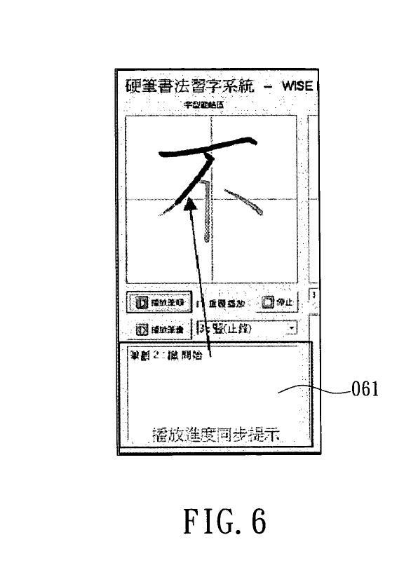

Refer to FIG. 6: The system can simultaneously play back the progress in a reminder area 061, represented as [symbol] to remind users about the progress.

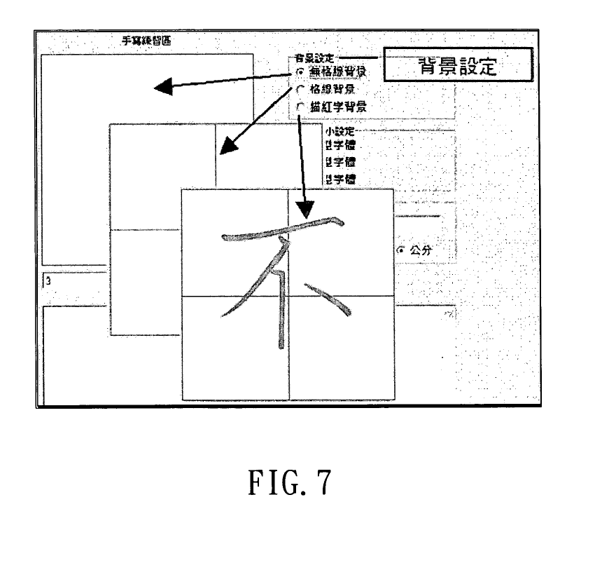

Refer to FIG. 7: The functions provided by the handwriting practice area in the hard pen calligraphy practicing subsystem allow the calligraphy learner to select a background as needed (a gridless background, a grid background, or a red character tracing background) for imitating and copying the selected font by selecting among the icons [symbol] , [symbol] , and [symbol] .

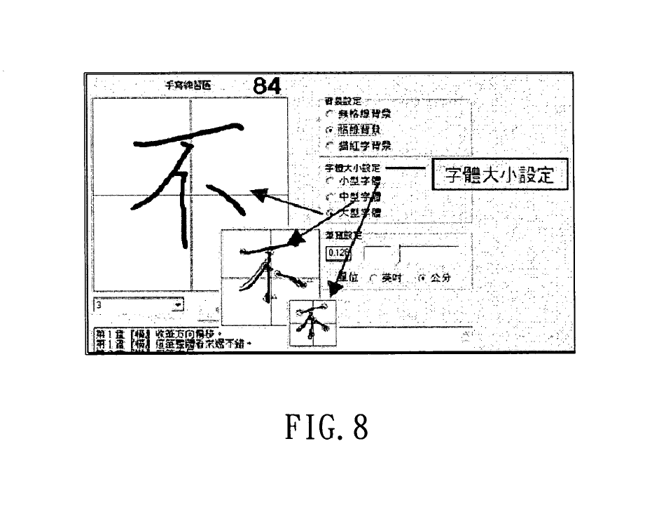

Refer to FIG. 8: The calligraphy learner can select the font size for imitating and copying a character by selecting the icons [symbol] , [symbol] , and [symbol] , which represent small, medium, and large font size, respectively.

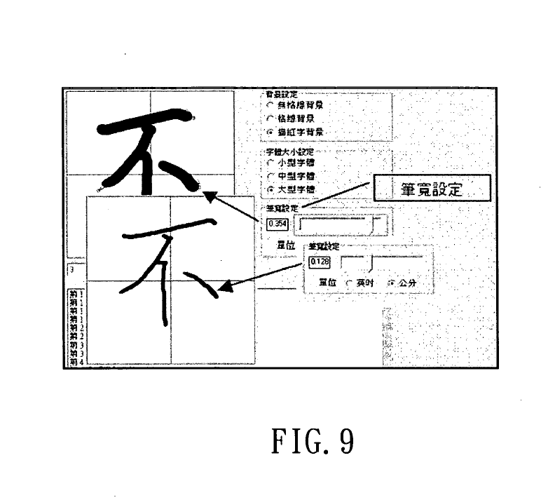

Refer to FIG. 9: The calligraphy learner can select the stroke width of the pen for imitating and copying a character by selecting the icon [symbol] .

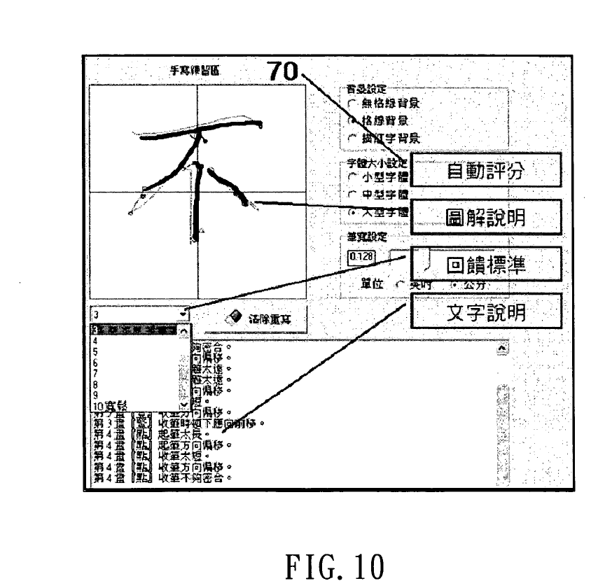

Refer to FIG. 10: The system can display the information of the imitation process and grade the writing, after the calligraphy learner has completed imitating and copying the Chinese character [symbol] .

The soft pen calligraphy practicing subsystem in a Chinese calligraphy practicing system is described as follows. The soft pen calligraphy practicing subsystem uses a tablet PC or a digital notepad to simulate the strokes of the traditional writing brush for writing in various fonts such as Regular Script, Ancient Style, Seal Character, Wei Stone script, and Inscription Bone Script. Besides being used for practicing writing characters, this system can save the calligraphy work as a file into a computer, print the calligraphy work, and repeat playing back the writing process. At present, the invention can detect the writing force according to the pressure of the pen detected by a tablet PC or a digital notepad to determine the thickness of strokes, and records the path and pressure of the writing for replays. Furthermore, the speed of the playback can be adjusted.

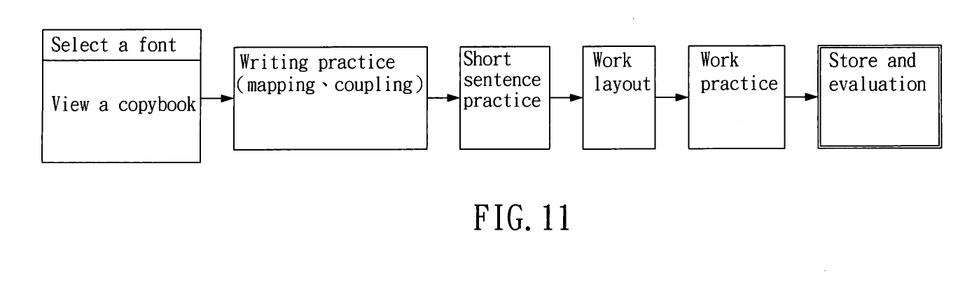

The soft pen calligraphy practicing subsystem of the present invention applies the refined learning strategy, the ideas of the framework concept, and the capability to write in various fonts including Regular Script, Ancient Style, Running Script, and Seal Character etc. are available for the auxiliary learning of the Chinese calligraphy learner. Because the level of difficulty of writing in different fonts varies, the invention allows Chinese calligraphy learners to set the level of difficulty for their practices from easy to difficult as they progress. The level of difficulty is in the order of regular script (elementary level), running script (advanced level), Cursive Script, Ancient Style, and Seal Character (advanced level). Through the learning process, the learners are recommended to select the font and view the copybook before starting to practice writing a mapping copy, a couplet, a short sentence, or a creation (layout), and finally the completion of the work. The work can be saved and mailed to the teacher for grading. This learning process is shown in FIG. 11.

The teaching mode for calligraphy teachers is substantially the same as the teaching model of the hard pen calligraphy subsystem, which includes motivation, key point explanation, demonstration, practice, evaluation, and appreciation. However, the “key point explanation and demonstration” and the “evaluation and appreciation” are different. The detailed teaching modes are described in Table 2.

TABLE 2
Comparison of teaching modes between traditional calligraphy
and online calligraphy art

| Teaching Mode of | | |
|---|---|---|
| Traditional | | |
| Calligraphy | | Teaching Mode of Online Calligraphy Art |
| 1. | Motivation | The contents of the course design include nine |
| 2. | Key-Point | major teaching events and are expressed in a |
| | Explanation | multimedia form (texts, graphics, photos, images, |
| 3. | Demonstration | and animations, etc). The teacher illustrates and |
| | | explains the contents according to the screen being |
| | | displayed, or directly writes the characters in the |
| | | autograph area, using a fine write pen to mark the |
| | | key points of the character. |
| 4. | Practice | The soft pen calligraphy practicing technique is |
| | A. Demo | used for practicing writing in a running script. |
| | B. Imitation | Since the system includes a built-in copybook, the |
| | C. Criticism | learner can freely select the character he or she |
| | D. Correction | would like to practice. Through the evaluation and |
| | E. Reimitation | feedback mechanism, the learner can control the |
| | F. Recorrection | learning condition and correct mistakes according |
| | | to the feedback received. |
| 5. | Evaluation and | The learner can upload the finished work through |
| | Appreciation | the system for the teacher to grade and use a built- |
| | | in recording feedback mechanism to describe any |
| | | mistakes made by the learner. Furthermore, the |
| | | learner can upload the work to a shared space and |
| | | view other learners' works and learn from them. |

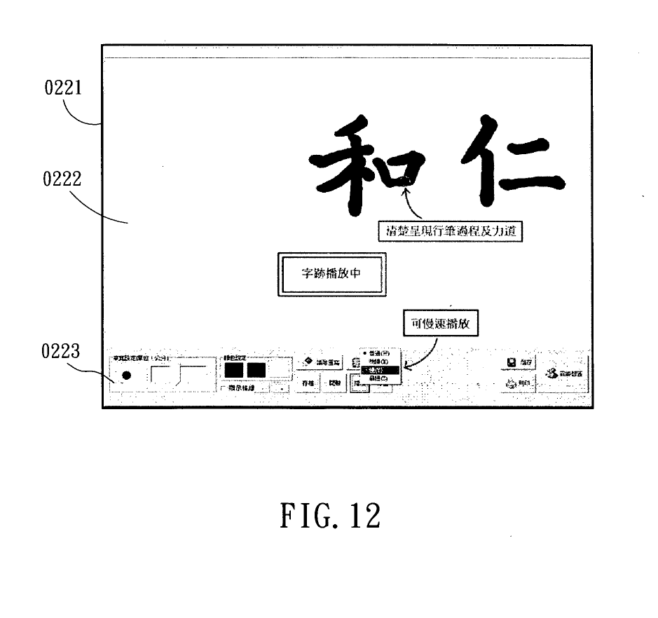

Refer to FIG. 12: The soft pen calligraphy practicing subsystem 0221 of the Chinese calligraphy practicing system disclosed in the present invention is made up of writing area 0222 and function setup area 0223. Writing area 0222 allows calligraphy learners to practice writing a character, and function setup area 0223 provides various different function setups.

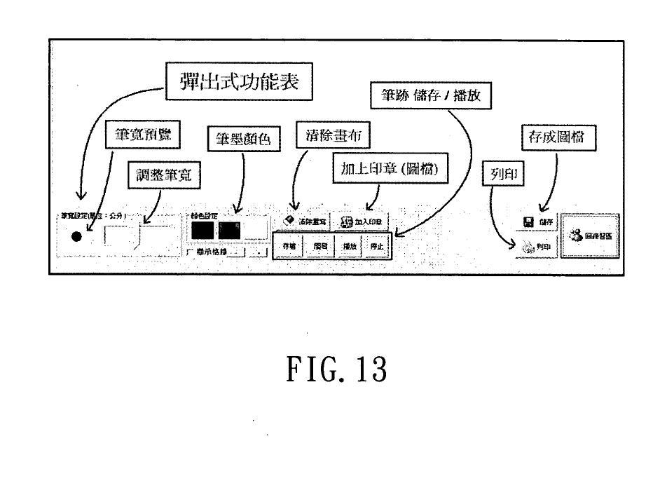

Refer to FIG. 13: Function setup area 0223 of the soft pen calligraphy practicing subsystem includes various functions such as a pop-up menu for setting stroke width, setting stroke width adjustment, setting ink color, clearing or erase, saving and replaying the strokes, adding a stamp, and saving as graphic file, etc., which are respectively represented by the icons [symbol] , [symbol] , [symbol] , [symbol] , [symbol] , [symbol] , [symbol] , [symbol] , and [symbol] .

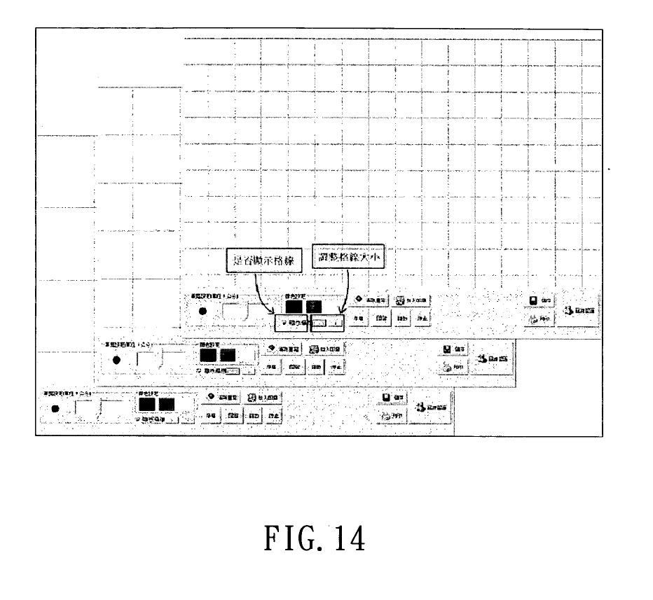

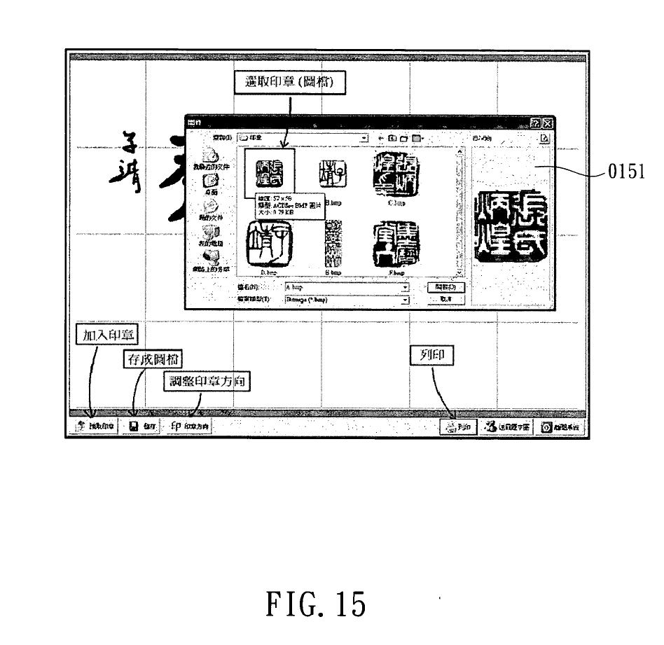

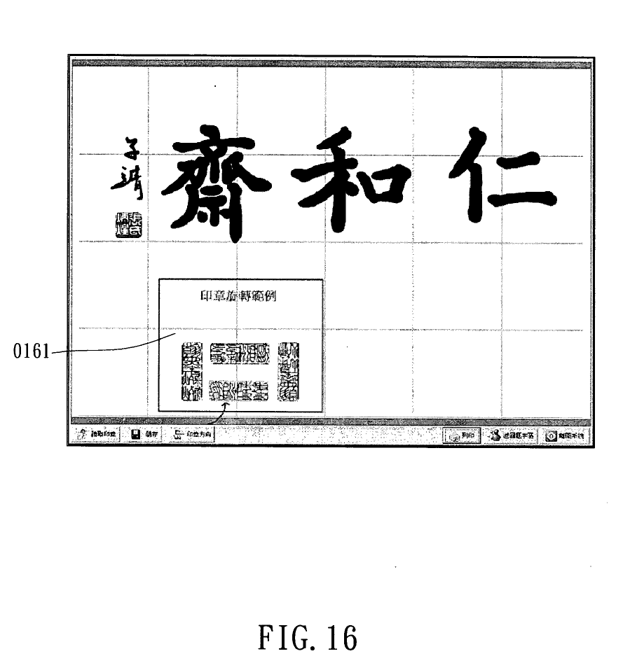

Refer to FIG. 14, Function setup of a writing area 0222 is shown. Writing area 0222 can set whether or not to display the grid and adjust the thickness of the grid lines, specified by the icon [symbol] . The soft pen calligraphy practice system of the present invention also can save the learner's writing in stamp form. In FIGS. 14 and 15, a character written by the learner can be saved as a graphic file in the form of a stamp. This stamp format can be selected and rotated as shown in graphic 0151 of FIG. 15 and graphic 0161 of FIG. 16.

In summary of the description above, the Chinese calligraphy practicing system of the invention comprises two subsystems: a hard pen calligraphy learning subsystem and a soft pen calligraphy learning subsystem that use artificial intelligence, expert system, computer graphics, image processing, and mode identification technologies to assist the calligraphy learning evaluation and allow the writing learning system to have an intelligent feedback function. As a result, users can immediately take note of the problems in their writing, make appropriate corrections promptly, and practice repeatedly until standard font and calligraphy art are achieved. In addition, this invention provides an original break-through teaching strategy, in contrast to traditional calligraphy teaching.

While the invention has been described by means of specific embodiments, numerous modifications and variations could be made thereto by artists without departing from the scope and spirit of the invention set forth in the claims. For example, the hard pen calligraphy learning technique adopts the standard Regular Script for illustrations, but it can also include Running Script, Cursive Script, and other fonts (such as Seal Character). In the soft pen calligraphy learning technique, the so-called “virtual brush” is adopted. The physical properties of the brush—the length of a nib of the brush, the radius of the nib of the brush, the number of hairs of the brush, and the ink storability—are set as parameters to construct a mathematical model. The parameters can be adjusted to write calligraphy in different strokes and to show the actual brush's properties.

Regarding teaching and learning, the preferred embodiment of the present invention uses a standalone machine for the illustration, but the invention is not limited to the standalone computer. The Internet, PDA, mobile phones, and related mobile carriers can be used to display the content. The scope of the content includes calligraphy practices and art appreciation, as well as character explanation for learning the language. The learning of the language is integrated into art appreciation, which not only provides studies of traditional calligraphy technique, but also includes the application of the language. For example, the model copybook of a single character, a poem, or a proverb emphasizes both the value of learning and the practical use of the language. The Chinese calligraphy practicing system is expected to be a useful tool for lifetime learning, and supports the national policy of developing lifetime learning. Chinese calligraphy can be digitalized and internationalized to greatly enhance the international cultural and educational influence of our country in the world.

What is claimed is:

1. A Chinese calligraphy practicing system, including a hard pen calligraphy practicing subsystem, and the subsystem comprising:
(a) a copybook area, further comprising:
(i) a model font display area, for displaying a model font selected form a copybook;
(ii) a stroke order playback icon, to be selected for playing back the stroke order of the model font;
(iii) a stroke playback icon, to be selected for playing back the stokes of the model font;
(iv) a repeat playback icon, to be selected for repeating the playback of an item selected form the group consisting of the stoke order and the stokes; and
(v) a reminder area, for synchronously playing back a progress reminder; and
(b) a practice area, comprising:
(i) a handwriting display area, for inputting a handwritten character;
(ii) a background setup icon, to be selected for setting a background;
(iii) a font size setup icon, to be selected for setting a font size of the character; and
(iv) a stroke width setup icon, to be selected for setting a stroke width of the character.

2. The Chinese calligraphy practicing system of claim 1, wherein the stroke order playback icon is selected to specify the stoke order of the font to be played back in full character.

3. The Chinese calligraphy practicing system of claim 1, wherein the stroke order playback icon is selected to specify the stoke order of the font to be played back repetitively.

4. The Chinese calligraphy practicing system of claim 1, wherein the stroke playback icon is selected to specify the strokes of the font that are to be played back.

5. The Chinese calligraphy practicing system of claim 1, wherein the stroke playback icon is selected to specify the strokes of the font that are to be played back repetitively.

6. The Chinese calligraphy practicing system of claim 1, wherein the speed of the stroke order and the strokes to be played back are adjustable.

7. The Chinese calligraphy practicing system of claim 1, wherein the word width of the model font is adjustable.

8. The Chinese calligraphy practicing system of claim 1, wherein the background setup function icon is selected to select a gridless background.

9. The Chinese calligraphy practicing system of claim 1, wherein the background setup function icon is selected to select a grid background.

10. The Chinese calligraphy practicing system of claim 1, wherein the background setup function icon is selected to select a character tracing background.

11. The Chinese calligraphy practicing system of claim 1, wherein the font size setup icon is selected for allowing the character to be adjusted to a size selected from the group consisting of a large font size, a medium font size, and a small font size.

12. The Chinese calligraphy practicing system of claim 1, comprising an automatic evaluation icon to be selected for evaluating the learning effect of a user.

13. The Chinese calligraphy practicing system of claim 1, comprising a learning standard setup icon to be selected for setting a learning standard for a user.

14. A Chinese calligraphy practicing system, including a soft pen calligraphy practicing subsystem, and the subsystem comprising:
(a) a writing area, for providing a function for a calligraphy learner to write a character; and
(b) function setup area, for setting various functions.

15. The Chinese calligraphy practicing system of claim 14, wherein the function setup area includes a stroke width icon for setting up the stoke width of the character.

16. The Chinese calligraphy practicing system of claim 14, wherein the function setup area includes an ink color icon for setting up the ink color of the character.

17. The Chinese calligraphy practicing system of claim 14, wherein the function setup area can set a grid line.

18. The Chinese calligraphy practicing system of claim 14, wherein the function setup area include a record/playback icon for enabling the handwritten character to be recorded and played back.

19. The Chinese calligraphy practicing system of claim 18, wherein the speed of playing back the handwritten character is adjustable.

20. The Chinese calligraphy practicing system of claim 14, wherein the handwritten character to be recorded is saved as a digital graphic file.

21. The Chinese calligraphy practicing system of claim 14, wherein the handwritten character to be recorded is saved as a stamp format.
